(19) United States
(12) Patent Application Publication
(10) Pub. No.: US 2017/0155999 A1
(43) Pub. Date: Jun. 1, 2017

(54) WIRED AND WIRELESS EARSET

(71) Applicant: HAEBORA CO., LTD., Seoul (KR)

(72) Inventor: Doo Sik SHIN, Seoul (KR)

(21) Appl. No.: 15/429,176

(22) Filed: Feb. 10, 2017

Related U.S. Application Data
(63) Continuation of application No. PCT/KR2015/008451, filed on Aug. 12, 2015.

(30) Foreign Application Priority Data
Aug. 18, 2014 (KR) 10-2014-0107203

(51) Int. Cl. H04R 1/10; G10L 21/0208

(52) U.S. Cl. CPC H04R 1/1041; H04R 1/1016; G10L 21/0208; H04R 2420/07; G10L 2021/02082

(57) ABSTRACT

The present disclosure relates to a wired and wireless earset, the earset comprising: a first earphone unit configured to be able to be inserted into a first external auditory canal of a user; a second earphone unit configured to be able to be inserted into a second external auditory canal of the user; and a main body connected to the first earphone unit, the second earphone unit and an external device, the main body comprising a switch setting up an operating mode to allow the earset to operate in one of a first mode and a second mode, and first and second speaker output adjusting circuits adjusting respective outputs of the first and second speakers in the first mode.

### CROSS-REFERENCE TO RELATED APPLICATION

This application is a continuation of a PCT international application filed on Aug. 12, 2015 and assigned Serial number PCT/KR2015/008451, which is based upon and claims the benefit of priority to Korea Patent Application No. 10-2014-0107203, filed on Aug. 18, 2014. The disclosures of the above-listed applications are hereby incorporated by reference herein in their entirety.

### BACKGROUND

Embodiments of the present invention relate to a wired and wireless earset, and more particularly, to a wired and wireless earset using an ear-insertion-type microphone.

With the growing use of mobile phones, hands-free earsets are being widely used, allowing mobile phone users to be engaged in other tasks while on the phone.

However, when a user uses an earset including an externally provided microphone under circumstances exposed to noise, the noise may be transmitted into the external microphone, thus obstructing the user from having an uninterrupted telephone conversation.

To address such issues, a microphone is installed within an earphone, such that ambient sound outside the ear of a user, such as, for example, a user voice signal provided from the mouth of the user and noise, is blocked, and only a user voice signal generated inside the ear is used to perform the telephone call.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

In general, to prevent echo caused by a phenomenon in which sound that is output from a speaker in an earphone is input to a microphone in the earphone, an output of a speaker in a microphone-installed earphone is adjusted. Thus, a difference between the output of the speaker in the microphone-installed earphone and an output of a speaker in an earphone not installed with a microphone occurs, resulting in imbalance between the speaker outputs.

Aspects of embodiments of the present invention are directed to a wired and wireless earset capable of adjusting an output of a speaker in an earphone unit including a microphone and an output of a speaker of an earphone unit absent a microphone, in a case of using an ear-insertion-type microphone in a first mode.

Aspects of embodiments of the present invention are also directed to a wired and wireless earset capable of maintaining balance between outputs of respective speakers in left and right earphone units.

The foregoing is illustrative only and is not intended to be in any way limiting. In addition to the illustrative aspects, embodiments, and features described above, further aspects, embodiments, and features will become apparent by reference to the drawings and the following detailed description.

### EFFECTS OF THE INVENTION

In accordance with the aforementioned invention, the problem caused by the imbalance of speaker output of left and right ear phones can be addressed because the speaker output of both earphones can be controlled even when a microphone is installed in only one of both earphones.

### BRIEF DESCRIPTION OF DRAWINGS

FIG. 1 is a schematic view illustrating a configuration of the wired and wireless earset 1 according to the exemplary embodiment.

FIG. 2 is a view illustrating an example of using the wired and wireless earset 1 of FIG. 1.

FIG. 3 is a schematic view illustrating a configuration of a mode setting unit 130 according to a first exemplary embodiment.

FIG. 4 is a view illustrating a circuit connection of the mode setting unit 130 of FIG. 3 in a first mode.

FIG. 5 is a view illustrating a circuit connection of the mode setting unit 130 of FIG. 3 in a second mode.

FIG. 6 is a view illustrating detailed configurations of first and second speaker output adjusting circuits 135 and 136 included in the mode setting unit 130 of FIG. 3.

FIG. 7 is a schematic view illustrating a configuration of the mode setting unit 130 according to the second exemplary embodiment.

FIG. 8 is a schematic view illustrating a configuration of the mode setting unit 130 according to the third exemplary embodiment.

FIG. 9 is a view illustrating a circuit connection of the mode setting unit 130 of FIG. 8 in the first mode.

FIG. 10 is a view illustrating a circuit connection of the mode setting unit 130 of FIG. 8 in the second mode.

### DETAILED DESCRIPTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A same reference mark used refers to a same element throughout the description.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

Hereinafter, exemplary embodiments with reference to a wired and wireless earset will be clearly understood from the following description taken in conjunction with the accompanying drawings.

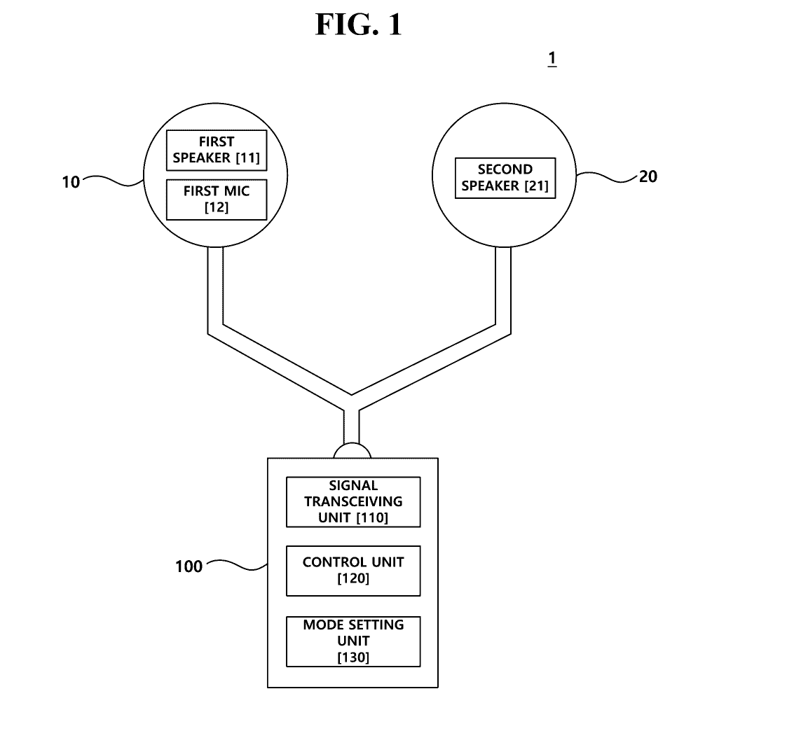

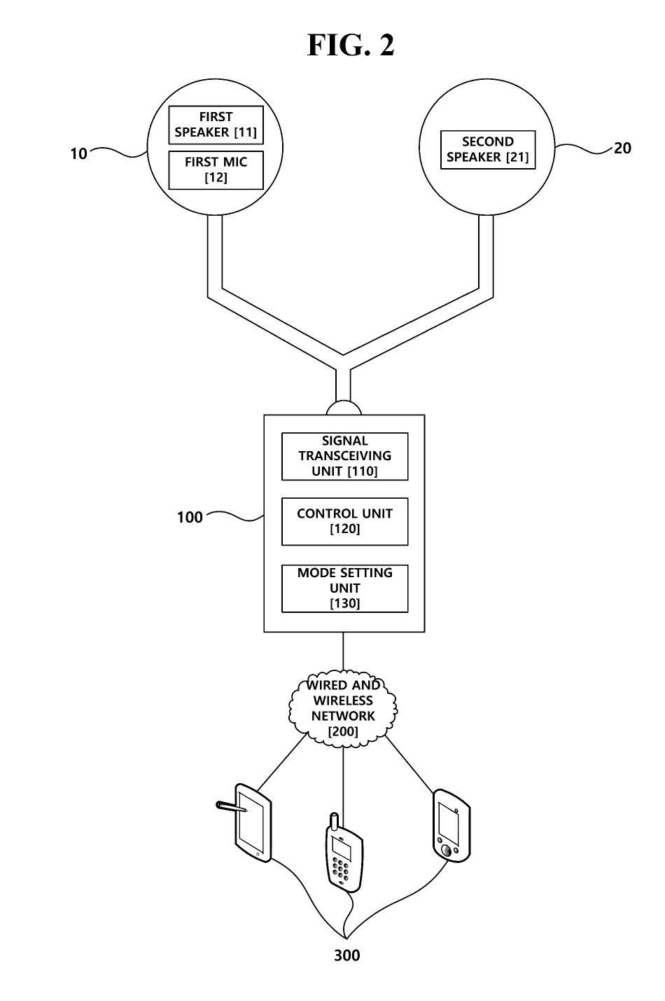

A wired and wireless earset 1 according to an exemplary embodiment will be described hereinbelow with reference to FIGS. 1 and 2. FIG. 1 is a schematic view illustrating a configuration of the wired and wireless earset 1 according to the exemplary embodiment; and FIG. 2 is a view illustrating an example of using the wired and wireless earset 1 of FIG. 1.

Referring to FIG. 1, the wired and wireless earset 1 may include a first earphone unit 10, a second earphone unit 20 and a main body 100. The first earphone unit 10, the second earphone unit 20 and the main body 100 are connected to one another in a wired manner. However, the connection thereamong is not limited thereto, and as necessary, the first earphone unit 10, the second earphone unit 20 and the main body 100y may be wirelessly connected to one another to transceive signals thereamong.

The first earphone unit 10 and the second earphone unit 20 may be inserted into both ears of a user. For example, the first earphone unit 10 may be inserted into a first external auditory canal of the user, and the second earphone unit 20 may be inserted into the first external auditory canal a second external auditory canal of another user. In other words, while the first earphone unit 10 may be inserted into an external auditory canal of a left ear of a user and the second earphone unit 20 may be inserted into an external auditory canal of a right ear of the user, the insertion of the earphone is not limited thereto. According to embodiments, the first earphone unit 10 may be inserted into an external auditory canal of a right ear of a user, and the second earphone unit 20 may be inserted into an external auditory canal of a left ear of the user.

While the first and second earphone units 10 and 20 may include first and second speakers 11 and 21, a microphone may only be included in the first earphone unit 10. However, the microphone is not limited thereto, and as necessary, a microphone may be installed in the second earphone 20.

For example, the first earphone unit 10 may include the first speaker 11 and a first microphone 12, and the second earphone unit 20 may include the second speaker 21. In other words, the first earphone unit 10 integrally formed with the first speaker 11 and the first microphone 12 may be inserted into an external auditory canal of one ear of a user, and the second earphone unit 20 including the second speaker 21 may be inserted into an external auditory canal of the other ear of the user.

Accordingly, the user may hear sound through the first and second speakers 11 and 21 inside the ear, and may speak through the first microphone 12 inside the ear. Through the use of the wired and wireless earset 1 according to the present exemplary embodiment, a speaker and a microphone may be placed inside the ear, whereby external noise may not be transmitted into the microphone. Thus, a user may have an uninterrupted telephone conversation even under extremely noisy circumstances, and may use both hands while speaking on the phone.

A user voice signal from vocal cords of a user may be generated as the user speaks, and the generated user voice signal may be provided to the first microphone 12 via a first external auditory canal of the user. In other words, since the first microphone 12 receives a user voice signal provided from the first external auditory canal of the user, the first microphone 12 may be a directional microphone which has directivity. However, the characteristic of the first microphone 12 is not limited thereto, and first microphone 12 may be an undirectional microphone which is absent directivity.

Referring to FIG. 1, the main body 100 may include a signal transceiving unit 110, a control unit 120 and a mode setting unit 130, and may be connected to the first and second earphone units 10 and 20. However, the components illustrated in FIG. 1 are not necessary at all times, and the main body 100 may include a less number of components than the number of components illustrated in FIG. 1.

Referring to FIG. 2, the wired and wireless earset 1 may be connected to an external device 300 through a wired and wireless network 200. A communication scheme between the wired and wireless earset 1 and the external device 300 may be unlimited, and the external device 300 may use any devices having a communication function, such as, for example, a mobile phone, a smart phone, and a tablet personal computer (PC).

In detail, the signal transceiving unit 110 may transceive signals to and from the external device 300, and a wireless communication scheme such as Blooth communication may be used to transceive signals. In other words, the signal transceiving unit 110 may transmit a voice signal of a user input from a second microphone 132 which is to be described further below, or may receive an acoustic signal or a voice signal from the external device 300. Accordingly, the first and second speakers 11 and 21 may output the acoustic signal or the voice signal provided from the external device 300. However, in a case of the main body 100 being connected to the external device 300 in a wired manner, the main body 100 may be provided absent the signal transceiving unit 110.

The control unit 120 may control an overall operation of the wired and wireless earset 1, and in detail, may control the first and second earphone units 10 and 20, the signal transceiving unit 110, and the mode setting unit 130 which is to be described further below. For example, the control unit 120 may control the wired and wireless earset 1 to allow user voice signals input to the first and second microphones 12 and 132 to be transmitted to the external device 300 and to allow the acoustic signal or the voice signal provided from the external device 300 to be transmitted to the first and second speakers 11 and 21 to be output therethrough.

The mode setting unit 130 may set up an operating mode of the wired and wireless earset 1. In detail, the wired and wireless earset 1 may operate in one of a first mode and a second mode. The first mode is a mode that is set up to allow a user to use the wired and wireless earset 1 under circumstances with noise exceeding a predetermined degree, for example, a noise mode. Since the first microphone 12 of the first earphone 10 operates in the first mode, a user may be able to have a telephone conversation with another person without being interrupted by noise, using the first microphone 12 inside the ear. However, given the fact that the first speaker 11 is adjacent to the first microphone 12 in the first earphone unit 10, an output of the first speaker 11 in the first mode may be adjusted to be reduced as compared to an output of the first speaker 11 in the second mode, such that echo and howling phenomena caused in the first microphone 12 by the output of the first speaker 11 may be prevented.

However, in the wired and wireless earset 1 according to the present exemplary embodiment, an output of the second speaker 21 which is spaced apart from the first microphone 12 as well as the output of the first speaker 11 adjacent to the first microphone 12 in the first mode may be reduced. For example, since the output of the second speaker 21 and the output of the second speaker 21 in the first mode may be reduced by the same amount, the outputs of the first and second speakers 11 and 21 may maintain balance therebetween.

The second mode is a mode that is set up to allow a user to use the wired and wireless earset 1 under circumstances with noise below a predetermined degree, for example, a general mode. Since the user is not exposed to noisy circumstances in the second mode, the first microphone 12 of the first earphone unit 10 may not operate in the second mode. In addition, since the user may not be affected by external noise in the second mode, the second microphone 132 that receives a user voice signal provided from the mouth of the user may operate as an external microphone included in the mode setting unit 130 of the main body 100 in the second mode. Further, the second microphone 132 is spaced apart from the first and second speakers 11 and 21, the second microphone 132 may not be affected by the outputs of the first and second speakers 11 and 21. Accordingly, since the outputs of the first and second speakers 11 and 21 do not need to be reduced, the user may be able to listen to music of relatively high output power.

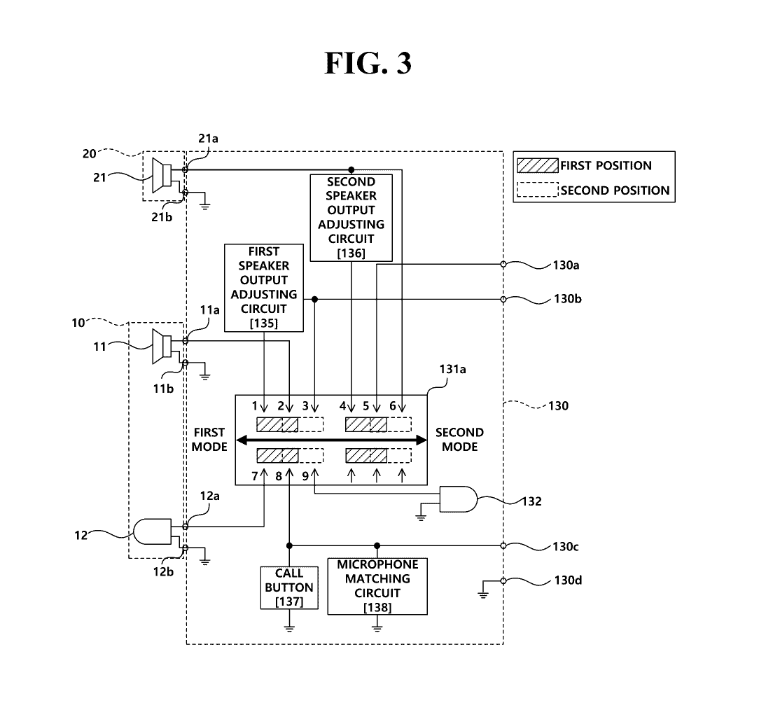

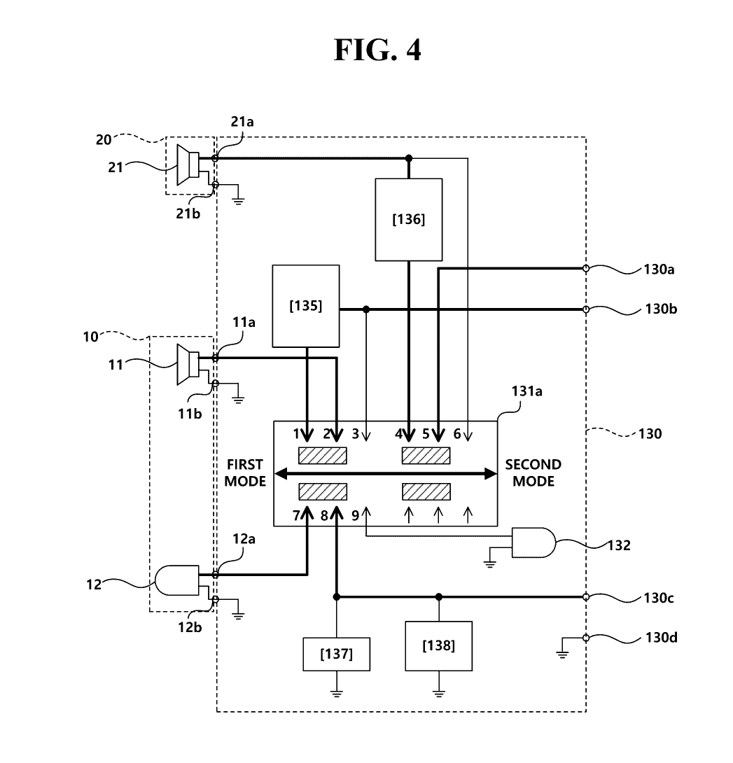

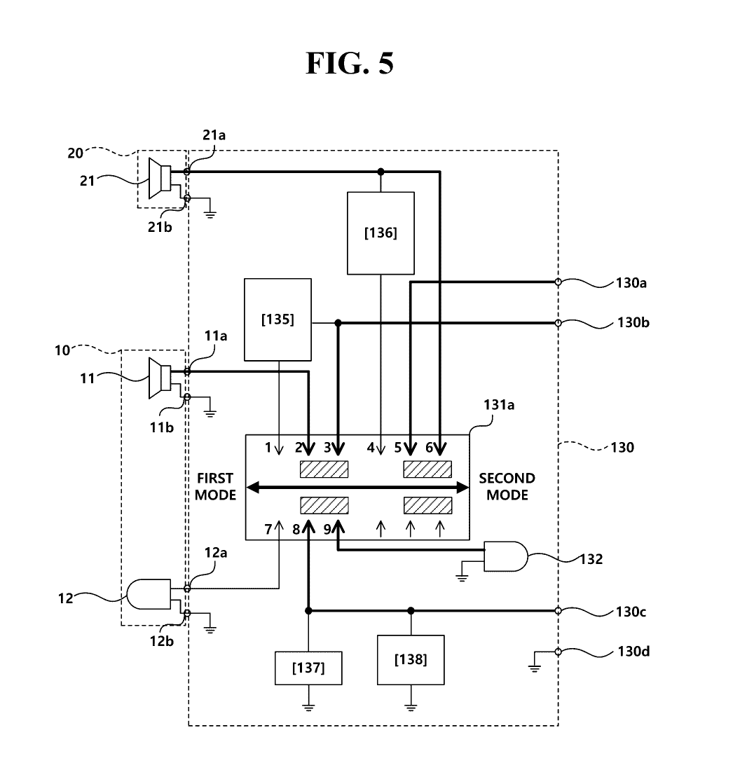

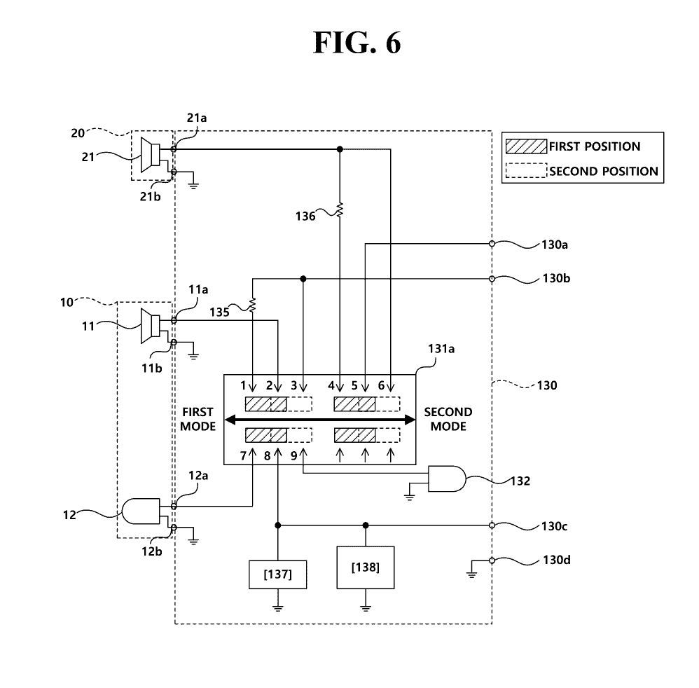

A detailed description on the mode setting unit 130 will be provided hereinbelow with reference to FIGS. 3, 4, 5, and 6. FIG. 3 is a schematic view illustrating a configuration of a mode setting unit 130 according to a first exemplary embodiment; FIG. 4 is a view illustrating a circuit connection of the mode setting unit 130 of FIG. 3 in a first mode; FIG. 5 is a view illustrating a circuit connection of the mode setting unit 130 of FIG. 3 in a second mode; and FIG. 6 is a view illustrating detailed configurations of first and second speaker output adjusting circuits 135 and 136 included in the mode setting unit 130 of FIG. 3.

Referring to FIG. 3, the mode setting unit 130 may provide a circuit that serves a function appropriate for a corresponding mode by dislocating a switch 131a based on each mode. In other words, the switch 131a may set up an operating mode to allow the wired and wireless earset 1 to operate in one of the first mode and the second mode. The switch 131a may include, for example, first to ninth terminals 1 to 9, and as necessary, the number of the terminals may be adjusted. However, the configuration, the shape, and the type (e.g. an analog switch or a digital switch) of the switch 131a are not limited to the examples illustrated in FIGS. 3, 4, and 5. According to embodiments, various switches that may modify a circuit based on the position of the switch 131a so as to serve functions appropriate for the first and second modes which are to be described further below may be used.

For example, in the first mode, the switch 131a may be at a first position to thereby allow a first terminal 1 to be connected to a second terminal 2, a fourth terminal 4 to be connected to a fifth terminal 5, and a seventh terminal 7 to be connected to an eighth terminal 8. In the second mode, the switch 131a may be at a second position to thereby allow the second terminal 2 to be connected to a third terminal 3, the fifth terminal 5 to be connected to a sixth terminal 6, and the eighth terminal 8 to be connected to a ninth terminal 9.

Meanwhile, the mode setting unit 130 may include ten terminals connected to other components, and the number of the terminals included in the mode setting unit 130 may be adjusted as necessary. For example, the mode setting unit 130 may include 1st-1st and 1st-2nd speaker terminals 11a and 11b connected to the first speaker 11 of the first earphone unit 10, 1st-1st and 1st-2nd microphone terminals 12a and 12b connected to the first microphone 12 of the first earphone unit 10, 2nd-1st and 2nd-2nd speaker terminals 21a and 21b connected to the second speaker 21 of the second earphone unit 20, and first to fourth external device terminals 130a, 130b, 130c, and 130d connected to the external device 300.

### [First Speaker 11 Output Circuit]

The second terminal 2 of the switch 131a is connected to the first speaker 11 via the 1st-1st speaker terminal 11a, and the first and third terminals 1 and 3 of the switch 131a may receive an acoustic signal or a voice signal provided from the external device 300 via the second external device terminal 130b. Accordingly, referring to FIGS. 4 and 5, the first speaker 11 may receive the acoustic signal or the voice signal provided from the external device 300 via the first terminal 1 in the first mode in which the switch 131a is at the first position, and may receive and output the acoustic signal or the voice signal provided from the external device 300 via the third terminal 3 in the second mode in which the switch 131a is at the second position

However, since the first speaker output adjusting circuit 135 is connected between the first terminal 1 of the switch 131a and the second external device terminal 130b, the acoustic signal or the voice signal provided from the external device 300 may be provided to the first speaker 11 via the first speaker output adjusting circuit 135 in the first mode, and the acoustic signal or the voice signal provided from the external device 300 may be provided to the first speaker 11 without passing through the first speaker output adjusting circuit 135 in the second mode.

The first speaker output adjusting circuit 135 may adjust an output of the first speaker 11 in the first mode, and in detail, may adjust the output of the first speaker 11 to be reduced in the first mode. To this end, the first speaker output adjusting circuit 135 may be configured of a resistor as illustrated in FIG. 6; however, the configuration of the first speaker output adjusting circuit 135 is not limited thereto.

### [Second Speaker 21 Output Circuit]

The fifth terminal 5 of the switch 131a may receive the acoustic signal or the voice signal provided from the external device 300 via the first external device terminal 130a, and the fourth and sixth terminals 4 and 6 of the switch 131a are connected to the second speaker 21 via the 2nd-1st speaker terminal 21a. Accordingly, referring to FIGS. 4 and 5, the second speaker 21 may receive the acoustic signal or the voice signal provided from the external device 300 via the fourth terminal 4 in the first mode in which the switch 131a is at the first position, and may receive and output the acoustic signal or the voice signal provided from the external device 300 via the sixth terminal 6 in the second mode in which the switch 131a is at the second position.

However, since the second speaker output adjusting circuit 136 is connected between the fourth terminal 4 of the switch 131a and the 2nd-1st speaker terminal 21a, the acoustic signal or the voice signal provided from the external device 300 may be provided to the second speaker 21 via the second speaker output adjusting circuit 136 in the first mode, and the acoustic signal or the voice signal provided from the external device 300 may be provided to the second speaker 21 without passing through the second speaker output adjusting circuit 136 in the second mode.

The second speaker output adjusting circuit 136 may adjust an output of the second speaker 21 in the first mode, and in detail, may adjust the output of the second speaker 21 to be reduced in the first mode. To this end, the second speaker output adjusting circuit 136 may be configured of a resistor as illustrated in FIG. 6. To maintain balance between the outputs of the first and second speakers 11 and 21, the first and second speaker output adjusting circuits 135 and 136 may be configured of resistors having the same magnitude; however, the magnitude of the resistor is not limited thereto.

In the mode setting unit 130 according to the present exemplary embodiment, since the output of the second speaker 21 as well as the output of the first speaker 11 which is adjacent to the first microphone 12 may be adjusted, output balance between the left and right speakers may be maintained, such that high-quality sound may be provided to a user.

### [Microphone Input Circuit]

The seventh terminal 7 of the switch 131a is connected to the first microphone 12 via the 1st-1st microphone terminal 12a, the ninth terminal 9 of the switch 131a is connected to the second microphone 132, and the eighth terminal 8 of the switch 131a is connected to the third external device terminal 130c. Accordingly, referring to FIGS. 4 and 5, the first microphone 12 embedded in the first earphone unit 10 operates in the first mode, and the second microphone 132 of the main body 100 may operate in the second mode. In detail, the external device 300 may receive, from the seventh terminal 7, a user voice signal that is provided through the first external auditory canal of the user in the first mode in which the switch 131a is at the first position, and may receive, from the ninth terminal 9, a user voice signal that is provided through the second microphone 132, which is an external microphone, in the second mode in which the switch 131a is at the second position.

Meanwhile, the third external device terminal 130c may be connected to a call button 137 and a microphone matching circuit 138. Accordingly, the user may control a call connection through the external device 300 by controlling the call button 137 of the main body 100. The microphone matching circuit 138 may enable a user voice signal provided from one of the first microphone 12 or the second microphone 132 to be successfully transmitted to the external device 300. In addition, while the microphone matching circuit 138 may include a zener diode and components such as, for example, R, L, and C, the configuration of the microphone matching circuit 138 is not limited thereto.

However, the configuration of the mode setting unit 130 according to the present exemplary embodiment is not limited to the example illustrated in FIG. 3, and the mode setting unit 130 may be modified into various configurations that may provide the aforementioned functions. In addition, as necessary, a bypass capacitor (decoupling capacitor) may be connected to the first and second microphone 12 and 132 and the first, second and third external device terminals 130a, 130b and 130c.

### [First Mode]

A description on the configuration of the mode setting unit 130 and an operation of the wired and wireless earset 1 in the first mode will be provided hereinbelow with reference to FIG. 4.

As the switch 131a is at the first position in the first mode, the first microphone 12 inside the ear of the user operates, thereby allowing the user to have a telephone conversation without being interrupted by noise under noisy circumstances.

An acoustic signal or a voice signal provided from the external device 300 may be output to the first and second speakers 11 and 21 via the first and second speaker output adjusting circuits 135 and 136, respectively. Accordingly, outputs of the first and second speakers 11 and 21 in the first mode may be adjusted by the first and second speaker output adjusting circuits 135 and 136 to be reduced as compared to outputs of the first and second speakers 11 and 21 in the second mode, respectively. Thus, since the output of the first speaker 11 is reduced, echo and howling phenomena occurring in the first microphone 12 may be prevented, and by reducing the outputs of all the first and second speakers 11 and 21, balance between the left and right speakers may be maintained.

### [Second Mode]

A description on the configuration of the mode setting unit 130 and an operation of the wired and wireless earset 1 in the second mode will be provided hereinbelow with reference to FIG. 5.

In the second mode, the switch 131a is at the second position, and an acoustic signal or a voice signal provided from the external device 300 may be output to the first and second speakers 11 and 21 without passing through the first and second speaker output adjusting circuits 135 and 136, respectively. Accordingly, unlike in the first mode, the reduction in the outputs of the first and second speakers 11 and 21 is absent in the second mode, and thus, a user may listen to music of relative high output power.

In the second mode, the second microphone 132, which is an external microphone, included in the main body 100 may operate, and due to not being exposed to noisy circumstances, the user may have an uninterrupted telephone conversation.

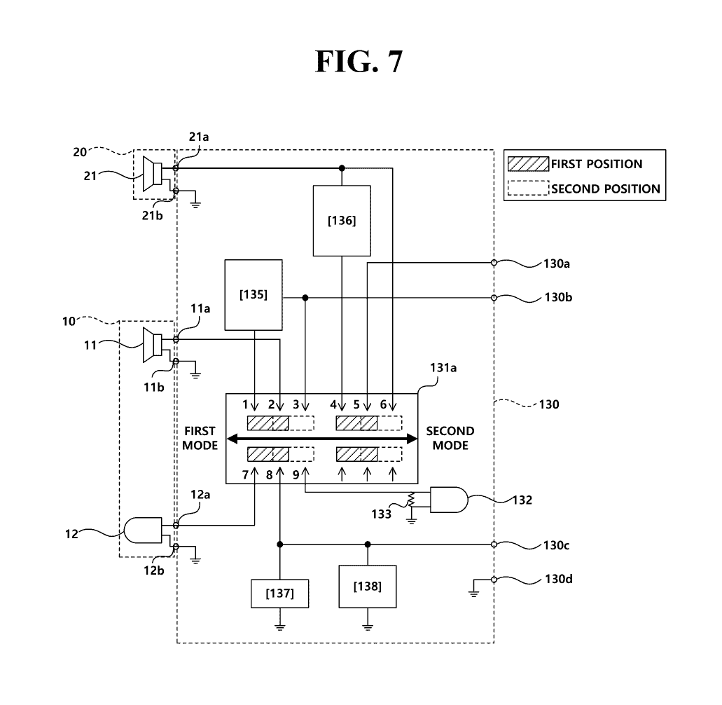

A description on a mode setting unit 130 according to a second exemplary embodiment will be provided hereinbelow with reference to FIG. 7. FIG. 7 is a schematic view illustrating a configuration of the mode setting unit 130 according to the second exemplary embodiment. However, features of the mode setting unit 130 according to the second exemplary embodiment that are different from those of the mode setting unit 130 according to the first exemplary embodiment will mainly be described herein.

Referring to FIG. 7, the second microphone 132 may include first and second terminals, the second terminal may be a ground terminal, and the first and second terminals may be connected to one another through a connection resistor 133.

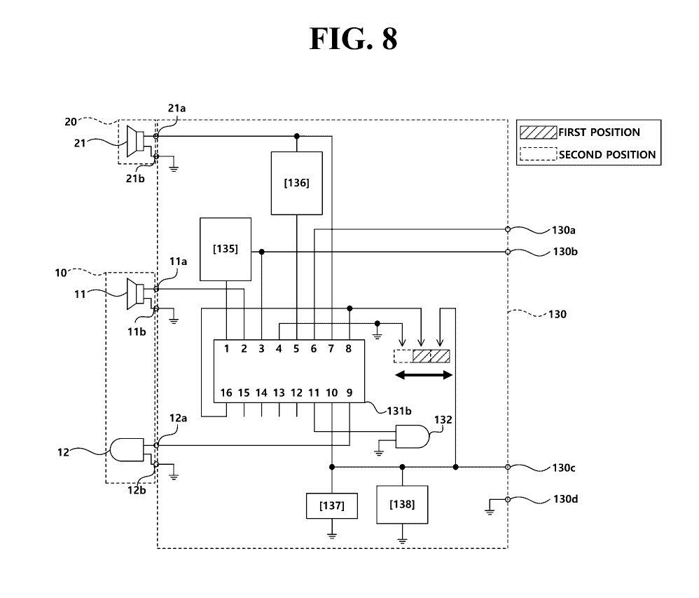

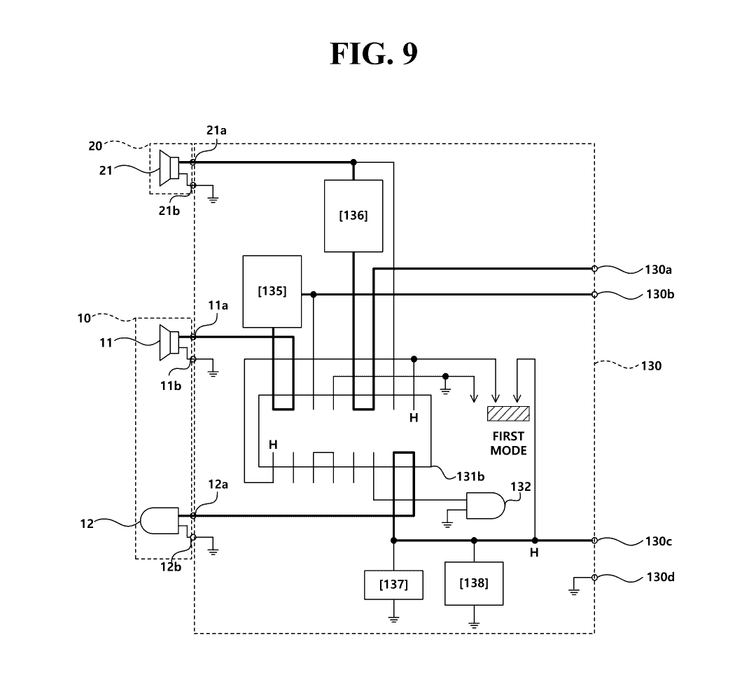

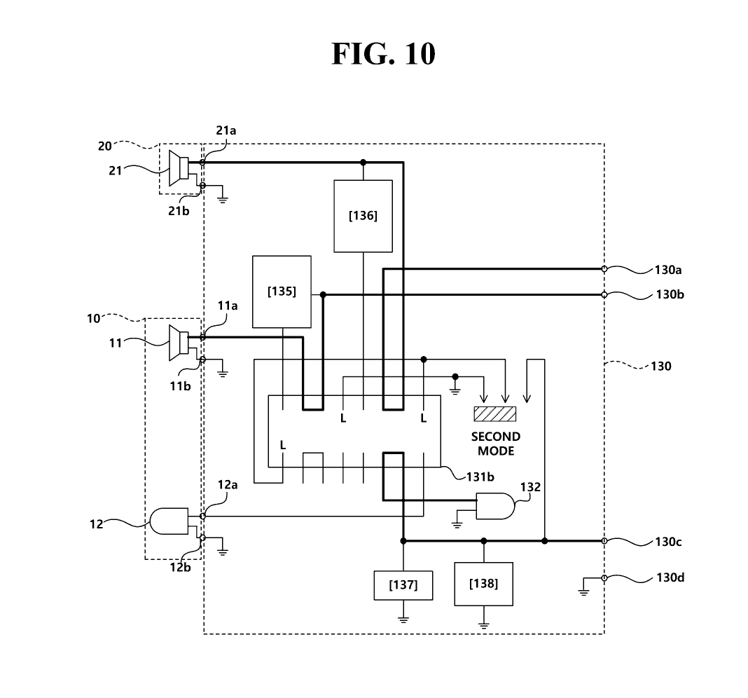

A description on a mode setting unit 130 according to a third exemplary embodiment will be provided hereinbelow with reference to FIGS. 8, 9 and 10. FIG. 8 is a schematic view illustrating a configuration of the mode setting unit 130 according to the third exemplary embodiment; FIG. 9 is a view illustrating a circuit connection of the mode setting unit 130 of FIG. 8 in the first mode; and FIG. 10 is a view illustrating a circuit connection of the mode setting unit 130 of FIG. 8 in the second mode. However, features of the mode setting unit 130 according to the third exemplary embodiment that are different from those of the mode setting unit 130 according to the first exemplary embodiment will mainly be described herein.

Referring to FIG. 8, the mode setting unit 130 according to the third exemplary embodiment may have a switch 131b having a configuration different from the configuration of the switch 131a of the mode setting unit 130 according to the first exemplary embodiment. In detail, the mode setting unit 130 may provide a circuit that serves a function appropriate for a corresponding mode by dislocating the switch 131b based on each mode. The switch 131b may include, for example, first to sixteenth terminals 1 to 16, and as necessary, the number of the terminals may be adjusted. However, the configuration, the shape, and the type (e.g. an analog switch or a digital switch) of the switch 131b are not limited to the examples illustrated in FIGS. 8, 9, and 10. According to embodiments, various switches that may modify a circuit based on the position of the switch 131b so as to serve functions appropriate for the first and second modes which are to be described further below may be used.

### [First Mode]

Referring to FIG. 9, in the first mode, the switch 131b may be at the first position, and as the third external device terminal 130c, the eighth terminal 8 and the sixteenth terminal 16 are connected to one another, a high signal H of the third external device terminal 130c may be input to the eighth terminal 8 and the sixteenth terminal 16.

Accordingly, the first terminal 1 and the second terminal 2 may be connected to one another, the fifth terminal 5 and the sixth terminal 6 may be connected to one another, the ninth terminal 9 and the tenth terminal 10 may be connected to one another, and the thirteenth terminal 13 and the fourteenth terminal 14 may be connected to one another.

Accordingly, as the first microphone 12 inside the ear of a user operates, the user may have a telephone conversation without being interrupted by noise under noisy circumstances.

An acoustic signal or a voice signal provided from the external device 300 may be output to the first and second speakers 11 and 21 via the first and second speaker output adjusting circuits 135 and 136, respectively. Accordingly, outputs of the first and second speakers 11 and 21 in the first mode may be adjusted by the first and second speaker output adjusting circuits 135 and 136 to be reduced, respectively. Thus, since the output of the first speaker 11 is reduced, echo and howling phenomena occurring in the first microphone 12 may be prevented, and by reducing the outputs of all the first and second speakers 11 and 21, balance between the left and right speakers may be maintained.

### [Second Mode]

Referring to FIG. 10, in the second mode, the switch 131b may be at the second position, and as the fourth terminal 4, the eighth terminal 8 and the sixteenth terminal 16 are connected to one another, a low signal L of the fourth terminal 4 may be input to the eighth terminal 8 and the sixteenth terminal 16. Accordingly, the second terminal 2 and the third terminal 3 may be connected to one another, the sixth terminal 6 and the seventh terminal 7 may be connected to one another, the tenth terminal 10 and the eleventh terminal 11 may be connected to one another, and the fourteenth terminal 14 and the fifteenth terminal 15 may be connected to one another.

In the second mode, the switch 131b is at the second position, and an acoustic signal or a voice signal provided from the external device 300 may be output to the first and second speakers 11 and 21 without passing through the first and second speaker output adjusting circuits 135 and 136, respectively. Accordingly, unlike in the first mode, the reduction in the outputs of the first and second speakers 11 and 21 is absent in the second mode, and thus, a user may listen to music of relative high output power.

In the second mode, the second microphone 132, which is an external microphone, included in the main body 100 may operate, and due to not being exposed to noisy circumstances, the user may have an uninterrupted telephone conversation.

As set forth above, according to one or more exemplary embodiments, although the microphone is only installed in one of the left and right earphones, outputs of the respective speakers of the left and right earphones may be adjusted, and accordingly, an imbalance issue between the outputs of the speakers of the left and right earphones may be addressed.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A wired and wireless earset, the earset comprising:
a first earphone unit configured to be able to be inserted into a first external auditory canal of a user, the first earphone unit comprising a first speaker outputting an acoustic signal or a voice signal provided from an external device, and a first microphone receiving a user voice signal provided via the first external auditory canal of the user;
a second earphone unit configured to be able to be inserted into a second external auditory canal of the user, the second earphone unit comprising a second speaker outputting an acoustic signal or a voice signal provided from an external device; and
a main body connected to the first earphone unit, the second earphone unit and an external device, the main body comprising a switch setting up an operating mode to allow the earset to operate in one of a first mode and a second mode, first and second speaker output adjusting circuits adjusting respective outputs of the first and second speakers in the first mode, and a second microphone receiving a user voice signal provided from the mouth of the user,
wherein the first microphone operates in the first mode and does not operate in the second mode,
wherein the first and second speaker output adjusting circuits address the imbalance caused by the first microphone between the outputs of the first and second speakers in the first mode by adjusting the outputs of the first and second speakers in the first mode to be reduced, respectively.

2. The earset of claim 3, wherein the outputs of the first and second speakers in the first mode are adjusted by the first and second speaker output adjusting circuits to be reduced as compared to outputs of the first and second speakers in the second mode, respectively.

3. The earset of claim 1, wherein the first and second speaker output adjusting circuits are configured of resistors having the same magnitude.

4. The earset of claim 1, wherein the second microphone comprises first and second terminals,
the first terminal and the second terminal are connected to one another via the resistor, and the second terminal is a ground terminal.
